(19) United States
(12) Patent Application Publication
(10) Pub. No.: US 2015/0075237 A1
(43) Pub. Date: Mar. 19, 2015

(54) CYLINDER LOCK

(71) Applicant: KABUSHIKI KAISHA HONDA LOCK, MIYAZAKI-SHI, MIYAZAKI (JP)

(72) Inventors: Mitsuo Sasaki, Miyazaki-shi (JP); Takuya Miyagawa, Miyazaki-shi (JP); Kazuki Moro, Miyazaki-shi (JP)

(21) Appl. No.: 14/396,169

(22) PCT Filed: Apr. 10, 2013
(86) PCT No.: PCT/JP2013/060806

§ 371 Date: Oct. 22, 2014

(30) Foreign Application Priority Data
Apr. 25, 2012 (JP) 2012-099710

(51) Int. Cl. E05B 27/00; E05B 29/00

(52) U.S. Cl. CPC E05B 27/001; E05B 27/0017; E05B 27/0021; E05B 27/0046; E05B 29/00
USPC 70/358

(57) ABSTRACT

In a cylinder lock, a half tumbler biased to engage an engagement portion with a locking recess of a cylinder body is inserted into a tumbler insertion hole of a rotor so that the engagement portion is retraced from the locking recess in response to insertion of a legitimate mechanical key into a key insertion hole. An inner side surface of the tumbler insertion hole is formed to include: a guide portion facing a half tumbler and extending in a moving direction of the half tumbler; and a passage forming portion having larger clearance with the half tumbler than that of the guide portion to form a release passage between the passage forming portion and the half tumbler such that the release passage faces the key insertion hole, extends in the moving direction of the half tumbler, and has opposite ends opened to an outer surface of the rotor.

### TECHNICAL FIELD

The present invention relates to a cylinder lock comprising: a rotor with a circular cross-sectional shape having a key insertion hole at its central part, the rotor being rotatably fitted into a fixed cylinder body and including tumbler insertion holes arranged on opposite sides or one side of one diametric line of the rotor and each having opposite ends opened to an outer surface of the rotor, the tumbler insertion holes being provided in a plurality of positions at intervals in an axial direction of the rotor while intersecting with part of the key insertion hole within planes orthogonal to an axis of the rotor; a plurality of half tumblers each having an engagement portion on one of opposite end portions along the one diametric line, the half tumblers being respectively inserted into the tumbler insertion holes in such a manner as to be movable between engagement positions to cause the engagement portions to protrude from the outer surface of the rotor and disengagement positions to retract the engagement portions back into the tumbler insertion holes in response to insertion of a legitimate mechanical key into the key insertion hole; springs respectively provided between the half tumblers and the rotor and configured to bias the half tumblers toward the engagement positions; and locking recesses extending in the axial direction of the rotor and being provided in inner surfaces of an upper side wall and a lower side wall of the cylinder body such that the engagement portions of the half tumblers located in the engagement positions are capable of being inserted into and engaged with the locking recesses.

### BACKGROUND ART

As disclosed in Patent Document 1, for example, there has heretofore been known a cylinder lock including: tumbler insertion holes, which are located in multiple positions at intervals in an axial direction of a rotor provided with a key insertion hole at a central part, and are provided in such a manner as to intersect with part of the key insertion hole; and half tumblers, which are provided with engagement portions engageable with locking recesses formed in an inner surface of a cylinder body, and are biased with springs in such a manner as to engage the engagement portions with the locking recesses. Here, the half tumblers are inserted into the tumbler insertion holes in such a manner as to disengage the engagement portions from the locking recesses in response to insertion of a legitimate mechanical key into the key insertion hole.

### Related Art Documents

### Patent Documents

Patent Document 1: Japanese Patent No. 3676606

### SUMMARY OF THE INVENTION

### Problems to be Solved by the Invention

However, in the cylinder lock disclosed in Patent Document 1 listed above, inner side surfaces of the tumbler insertion holes that face two side surfaces of the half tumblers are formed into flat shapes in such a manner as to closely face the side surfaces of the half tumblers. Accordingly, there is a possibility that smooth actions of the half tumblers are inhibited by a foreign object such as dust getting inside the key insertion hole or abrasion powder generated by contact between the half tumbler and the mechanical key, which may get stuck between the inner side surface of the tumbler insertion hole and the side surface of the half tumbler.

The present invention has been made in view of the above-mentioned circumstance. An object of the present invention is to provide a cylinder lock that guarantees smooth actions of half tumblers by releasing a foreign object, which gets into a tumbler insertion hole through a key insertion hole, out to a locking recess side of a cylinder body.

### Means for Solving the Problems

In order to achieve the object, according to a first feature of the present invention, there is provided a cylinder lock comprising: a rotor with a circular cross-sectional shape having a key insertion hole at its central part, the rotor being rotatably fitted into a fixed cylinder body and including tumbler insertion holes arranged on opposite sides or one side of one diametric line of the rotor and each having opposite ends opened to an outer surface of the rotor, the tumbler insertion holes being provided in a plurality of positions at intervals in an axial direction of the rotor while intersecting with part of the key insertion hole within planes orthogonal to an axis of the rotor; a plurality of half tumblers each having an engagement portion on one of opposite end portions along the one diametric line, the half tumblers being respectively inserted into the tumbler insertion holes in such a manner as to be movable between engagement positions to cause the engagement portions to protrude from the outer surface of the rotor and disengagement positions to retract the engagement portions back into the tumbler insertion holes in response to insertion of a legitimate mechanical key into the key insertion hole; springs respectively provided between the half tumblers and the rotor and configured to bias the half tumblers toward the engagement positions; and locking recesses extending in the axial direction of the rotor and being provided in inner surfaces of an upper side wall and a lower side wall of the cylinder body such that the engagement portions of the half tumblers located in the engagement positions are capable of being inserted into and engaged with the locking recesses, characterized in that inner side surfaces of each of the tumbler insertion holes facing the corresponding half tumbler from opposite sides are each formed to include at least: a guide portion closely facing the half tumbler and extending in a moving direction of the half tumbler; and a passage forming portion having larger clearance between the passage forming portion and the half tumbler than clearance between the guide portion and the half tumbler in such a manner as to form a release passage between the passage forming portion and the half tumbler such that the release passage crosses a side edge portion of the key insertion hole, extends in the moving direction of the half tumbler, and has opposite ends opened to the outer surface of the rotor.

According to a second feature of the present invention, in addition to the configuration of the first feature, each inner side surface of each tumbler insertion hole is formed to include: the guide portion; and one or a plurality of other guide portions each closely facing the half tumbler and extending in the moving direction of the half tumbler, the guide portion and the other guide portion having a space therebetween in a direction orthogonal to the moving direction of the half tumbler.

### Effects of the Invention

With the first feature of the present invention, the guide portion constituting part of the inner side surface of the tumbler insertion hole closely faces the half tumbler and extends in the moving direction of the half tumbler. Thus, the release passage facing the side edge portion of the key insertion hole, extending in the moving direction of the half tumbler, and having opposite ends opened to the outer surface of the rotor is formed between the inner side surface of the tumbler insertion hole and the side surface of the half tumbler while enabling the guide portion to guide the movement of the half tumbler between the engagement position and disengagement portion of the half tumbler. It is thus possible to cause a foreign object such as dust getting inside the key insertion hole or abrasion powder generated by contact between the half tumbler and the mechanical key to drop down from the release passage and thereby to discharge the foreign object to the locking recess side formed in the inner surface of the cylinder body. In this way, the foreign object is prevented from being stuck between the inner side surface of the tumbler insertion hole and the side surface of the half tumbler, and a smooth action of the half tumbler can be guaranteed.

Moreover, with the second feature of the present invention, the inner side surface of the tumbler insertion hole is formed such that the guide portions are provided in multiple positions at an interval in the direction orthogonal to the moving direction of the half tumbler. Thus, the movement of the half tumbler can be guided while minimizing the chance of a foreign object being stuck between the guide portion and the side surface of the half tumbler.

### BRIEF DESCRIPTION OF THE DRAWINGS

FIG. 1 shows a first embodiment and is an exploded perspective view of a cylinder lock. (first embodiment)

FIG. 2 is a cross-sectional view of the cylinder lock at a third engagement position in a state where a mechanical key is not inserted. (first embodiment)

FIG. 3 is a cross-sectional view of the cylinder lock at the third engagement position in a state where the mechanical key is inserted. (first embodiment)

FIG. 4 is a sectional view taken along a line 4-4 in FIG. 3. (first embodiment)

FIG. 5 is a sectional view taken along a line 5-5 in FIG. 3. (first embodiment)

FIG. 6 shows a second embodiment and is a cross-sectional view of a cylinder lock which corresponds to FIG. 2 in a state where a mechanical key is inserted. (second embodiment)

FIG. 7 is a sectional view taken along a line 7-7 in FIG. 6. (second embodiment)

FIG. 8 is a sectional view taken along a line 8-8 in FIG. 6. (second embodiment)

### EXPLANATION OF REFERENCE NUMERALS AND SYMBOLS

12 . . . Cylinder body

13 . . . Rotor

14 . . . Key insertion hole

18, 19, 20, 21, 22, 23, 24, 25, 26 . . . Tumbler insertion hole

29, 30, 31, 32, 33, 34, 35, 36, 37 . . . Half tumbler

38, 39, 40, 41, 42, 43, 44, 45, 46 . . . Spring

47 . . . Engagement portion

49, 50, 51, 52 . . . Locking recess

54, 64 . . . Inner side surface of tumbler insertion hole

55, 56, 65, 66, 67 . . . Guide portion

57, 68 . . . Passage forming portion

59, 70 . . . Release passage

L . . . One diametric line

### MODES FOR CARRYING OUT THE INVENTION

Embodiments of the present invention will be described below referring to the attached drawings.

### First Embodiment

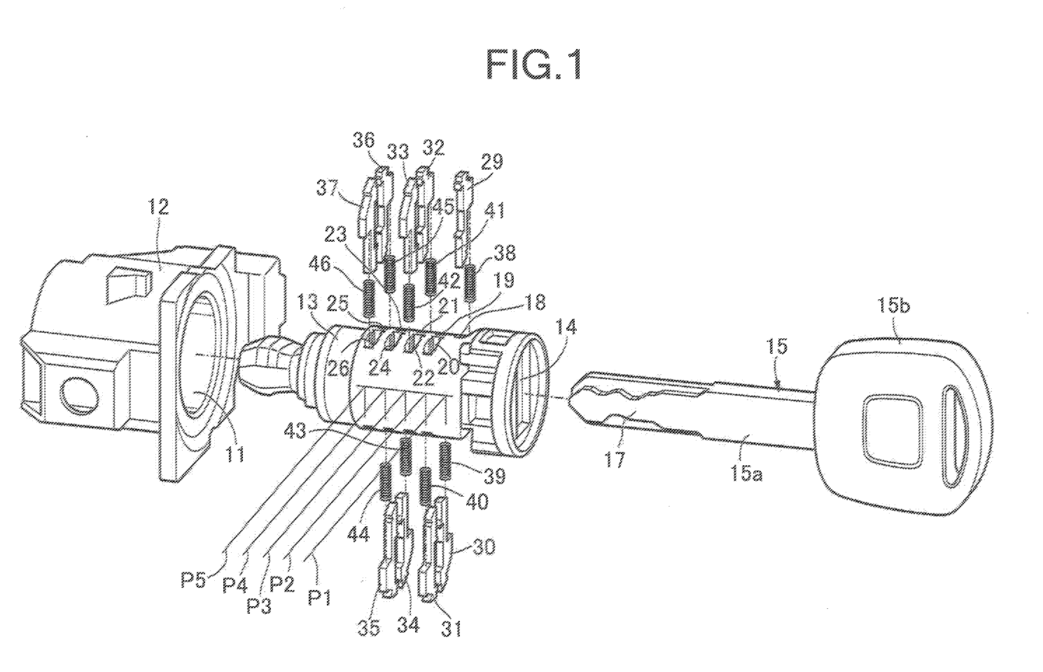

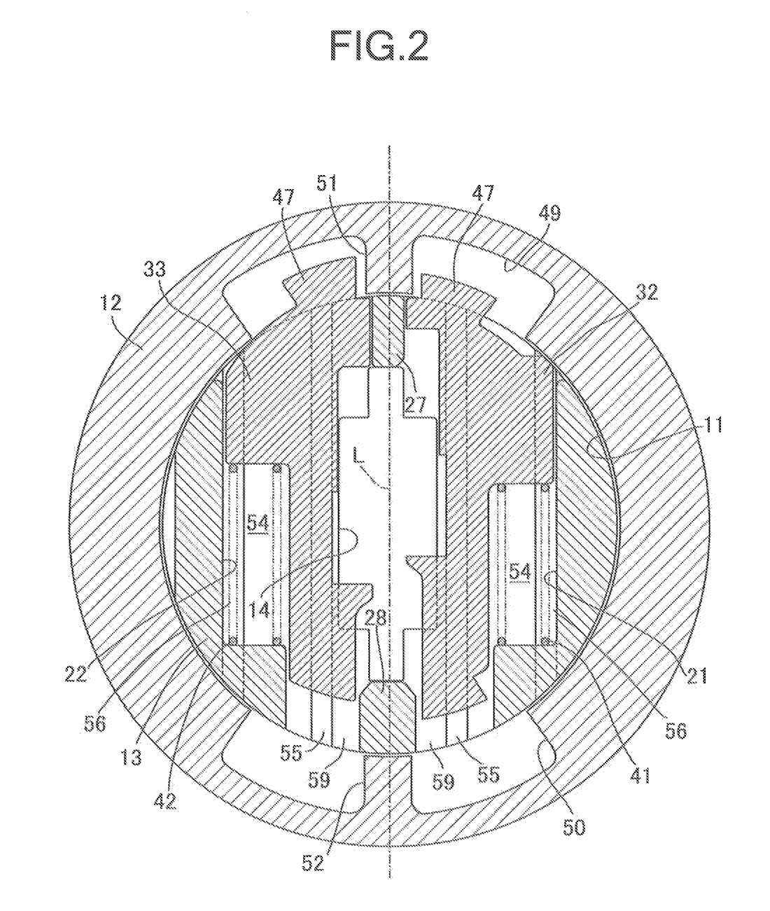

A first embodiment of the present invention will be described with reference to FIG. 1 to FIG. 5. First, referring to FIG. 1 and FIG. 2, this cylinder lock includes a fixed cylinder body 12 having a cylinder hole 11, and a rotor 13 formed into a circular cross-sectional shape and rotatably fitted into the cylinder hole 11. A bottomed key insertion hole 14 having one end opened to an end surface of the rotor 13 is provided at a central part of the rotor 13 in such a manner as to extend in an axial direction of the rotor 13.

The rotor 13 can be engaged with the cylinder body 12 in multiple positions provided at intervals in the axial direction of the rotor 13, in this embodiment, in five positions of first to fifth engagement positions P1, P2, P3, P4, P5. In the engaged state, rotation of the rotor 13 relative to the cylinder body 12 is inhibited. Meanwhile, when a legitimate mechanical key 15 is inserted into the key insertion hole 14, the rotor 13 is disengaged from the cylinder body 12 so that the rotor 13 can be rotatably driven inside the cylinder body 12 by operating the mechanical key 15.

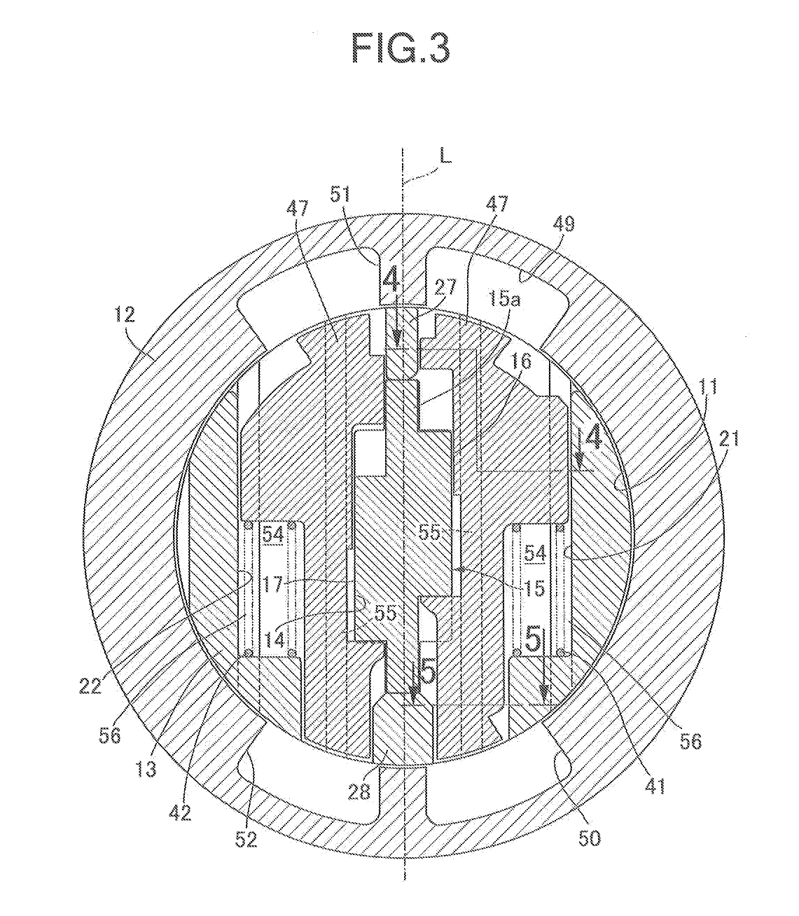

Referring to FIG. 3 together, the mechanical key 15 is formed by connecting an operating part 15b integrally to a rear end of a key main part 15a, which extends straight with a rectangular cross-sectional shape. Projections 16, 17 are formed at central parts on a tip end side of two surfaces of the key main part 15a by cutting into opposite sides of the two surfaces on the tip end side. The projections 16, 17 have shapes that sequentially change along transition in a longitudinal direction of the key main part 15a. The projections 16, 17 may have mutually the same shape or may have mutually different shapes.

In the rotor 13, tumbler insertion holes arranged on either opposite sides or one side of one diametric line L of the rotor 13 and each having opposite ends opened to an outer surface of the rotor 13 within a plane orthogonal to an axis of the rotor 13 are provided in multiple positions at intervals in the axial direction of the rotor 13, namely, in five positions of the first to fifth engagement positions P1 to P5 while intersecting with part of the key insertion hole 14. In the third engagement position P3, the rotor 13 is provided with a pair of tumbler insertion holes 21, 22 arranged on opposite sides of the one diametric line L of the rotor 13 and each having opposite ends opened to the outer surface of the rotor 13 within a plane orthogonal to the axis of the rotor 13, the tumbler insertion holes 21, 22 being provided in such a manner as to intersect with part of the key insertion hole 14. A pair of partition walls 27, 28 to be arranged in such positions on the one diametric line L of the rotor 13 to sandwich the key insertion hole 14 are formed between the tumbler insertion holes 21, 22.

Half tumblers 32, 33 having engagement portions 47 each located on one of opposite ends along the one diametric line L are respectively inserted into the tumbler insertion holes 21, 22 in such a manner as to be movable between engagement positions to cause the engagement portions 47 to protrude from the outer surface of the rotor 13 as shown in FIG. 2 and disengagement positions to retract the engagement portions 47 back into the tumbler insertion holes 21, 22 in response to insertion of the legitimate mechanical key 15 into the key insertion hole 14 as shown in FIG. 3. Springs 41, 42 provided between the half tumblers 32, 33 and the rotor 13 and configured to bias the half tumblers 32, 33 toward the engagement positions are housed inside the tumbler insertion holes 21, 22, respectively.

In the second, fourth, and fifth engagement positions P2, P4, P5 of the rotor 13, tumbler insertion holes 19, 20; 23, 24; 25, 26 arranged on opposite sides of the one diametric line L of the rotor 13 and each having opposite ends opened to the outer surface of the rotor 13 within planes orthogonal to the axis of the rotor 13 are provided in such a manner as to intersect with part of the key insertion hole 14 as in the third engagement position P3. Moreover, half tumblers 30, 31; 34, 35; 36, 37 are inserted into the tumbler insertion holes 19, 20; 23, 24; 25, 26, respectively, and springs 39, 40; 43, 44; 45, 46 to be housed inside the tumbler insertion holes 19, 20; 23, 24; 25, 26 are provided between the half tumblers 30, 31; 34, 35; 36, 37 and the rotor 13, respectively.

Meanwhile, in the first engagement position P1, a single tumbler insertion hole 18 arranged on one side of the one diametric line L of the rotor 13 and having opposite ends opened to the outer surface of the rotor 13 within a plane orthogonal to the axis of the rotor 13, is provided in the rotor 13 in such a manner as to intersect with part of the key insertion hole 14. A spring 38 is provided between a half tumbler 29 to be inserted into the tumbler insertion hole 18 and the rotor 13 in such a manner as to be housed inside the tumbler insertion hole 18.

In the meantime, two pairs of locking recesses 49, 50; 51, 52 corresponding to the ends of the respective tumbler insertion holes 18; 19, 20; 21, 22; 23, 24; 25, 26 in the state where a rotational position of the rotor 13 is in a neutral position, are provided in inner surfaces of an upper side wall and a lower side wall of the cylinder body 12 in such a manner as to enable the engagement portions 47 of the half tumblers 29; 30, 31; 32, 33: 34, 35; 36, 37 to be inserted into and engaged with one of the pairs of the locking recesses 49, 50; 51, 52.

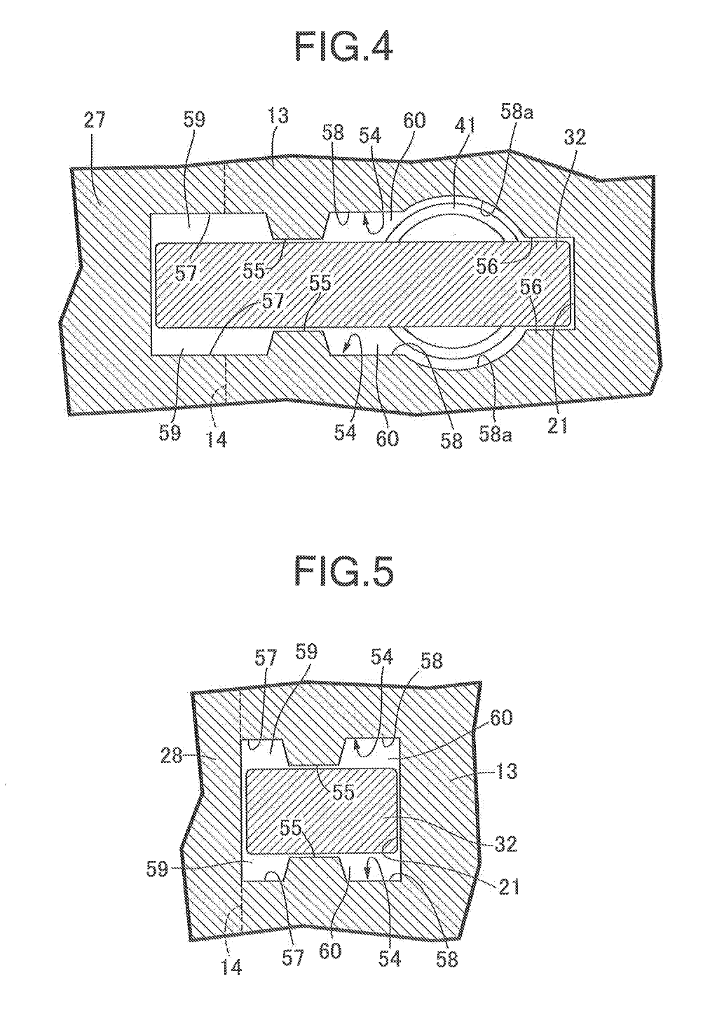

Referring to FIG. 4 and FIG. 5 together, inner side surfaces 54 that belong to one 21 of the pair of tumbler insertion holes 21, 22 in the third engagement position P3 and face the half tumbler 32 from opposite sides, are formed to include at least: first guide portions 55 closely facing the half tumbler 32 and extending in a moving direction of the half tumbler 32; and first passage forming portions 57 having larger clearances with the half tumbler 32 than those of the first guide portions 55 in such a manner as to form first release passages 59 in spaces with the half tumbler 32 such that each first release passage 59 crosses a side edge portion of the key insertion hole 14, extends in the moving direction of the half tumbler 32, and has opposite ends opened to the outer surface of the rotor 13. In this embodiment, the inner side surfaces 54 of the tumbler insertion hole 21 are formed to have the first guide portions 55, and second guide portions 56 closely facing the half tumbler 32 and extending in the moving direction of the half tumbler 32 while providing intervals in a direction orthogonal to the moving direction of the half tumbler 32. The inner side surfaces 54 between the first and second guide portions 55, 56 include the second passage forming portions 58 having larger clearances with the half tumbler 32 than those of the first and second guide portions 55, 56 in such a manner as to form second release passages 60, each of which extends in the moving direction of the half tumbler 32 and has opposite ends opened to the outer surface of the rotor 13 as similar to the first release passages 59, in spaces with the half tumbler 32.

Moreover, part of each second passage forming portion 58 is formed to include a curved portion 58a in an arc shape for housing the spring 41 having a coil shape.

The inner side surfaces of the other tumbler insertion hole 22 in the third engagement position P3, and the inner side surfaces of the tumbler insertion holes 18 to 20 and 23 to 26 in the first, second, fourth, and fifth engagement positions P1, P2, P4, P5 are formed similarly to the inner side surfaces of the tumbler insertion hole 21 in the third engagement position P3.

Next, operations of the first embodiment will be described. The inner side surfaces 54 of the tumbler insertion holes 18 to 26 facing the half tumblers 29 to 37 from opposite sides are formed to include at least: the first guide portions 55 closely facing the half tumblers 29 to 37 and extending in the moving directions of the half tumblers 29 to 37; and the first passage forming portions 57 having larger clearances with the half tumblers 29 to 37 than those of the first guide portions 55 in such a manner as to form the first release passages 59 in the spaces with the half tumblers 29 to 37 such that each first release passage 59 crosses the side edge portion of the key insertion hole 14, extends in the moving directions of the corresponding one of the half tumblers 29 to 37, and has opposite ends opened to the outer surface of the rotor 13. Accordingly, a foreign object such as dust getting inside the key insertion hole 14 or abrasion powder generated by contact between any of the half tumblers 29 to 37 and the mechanical key 15 can be dropped down from any of the first release passages 59 and be discharged to any of the lower locking recesses 50, 52 among the locking recesses 49, 50; 51, 52 provided in the inner surface of the cylinder body 12. In this way, the foreign object is prevented from being stuck between any of the inner side surfaces 54 of the tumbler insertion holes 18 to 26 and the side surface of any of the half tumblers 29 to 37, and smooth actions of the half tumblers 29 to 37 can be guaranteed.

In addition, the inner side surfaces 54 of the tumbler insertion holes 18 to 26 are formed to have the first guide portions 55, and the second guide portions 56 closely facing the half tumblers 29 to 37 and extending in the moving directions of the half tumblers 29 to 37, while providing the interval in the direction orthogonal to the moving directions of the half tumblers 29 to 37. Thus, the movements of the half tumblers 29 to 37 can be guided while minimizing the chance of the foreign object being stuck between any of the first and second guide portions 55, 56 and the side surface of any of the half tumblers 29 to 37.

### Second Embodiment

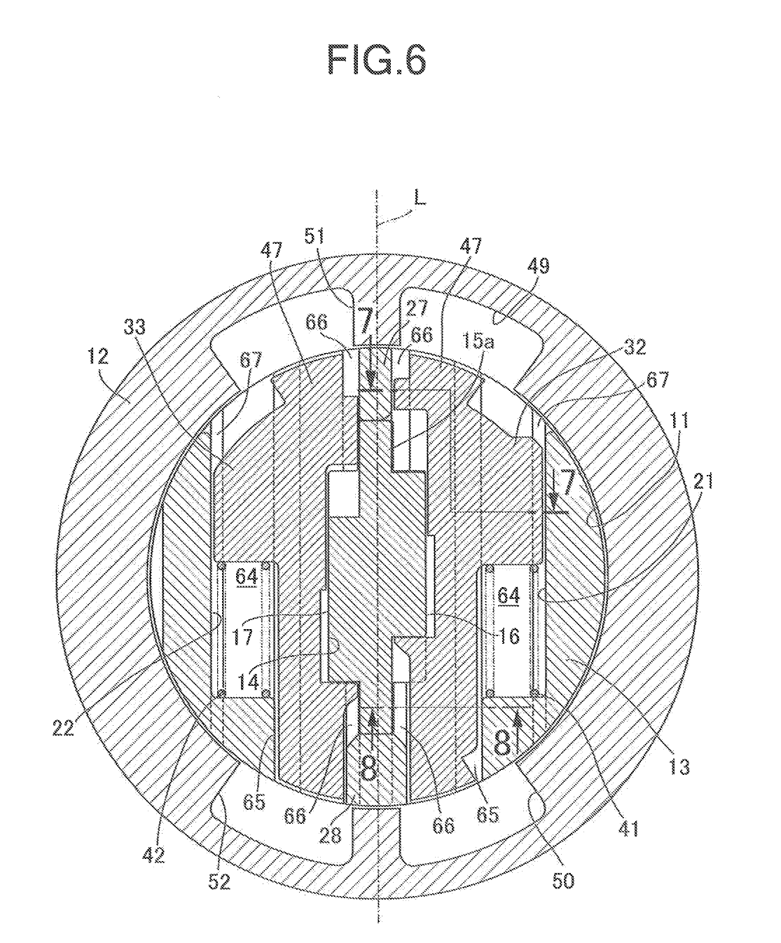

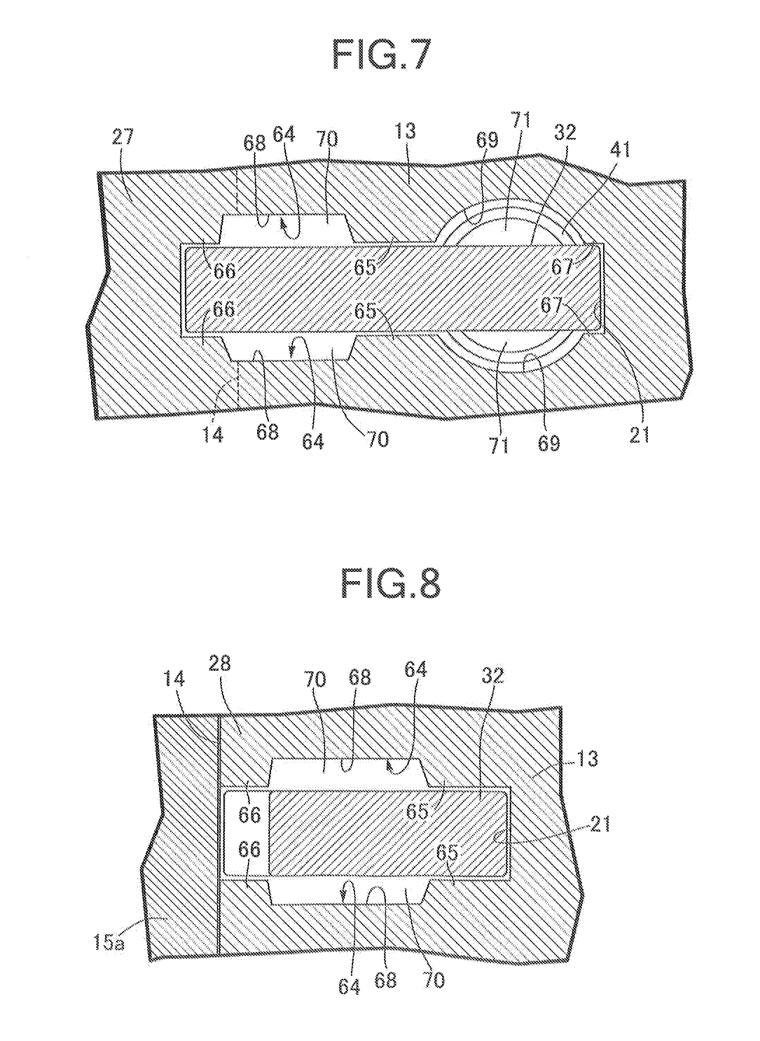

A second embodiment of the present invention will be described with reference to FIG. 6 to FIG. 8. Note that constituents corresponding to those in the first embodiment will simply be illustrated with denotation of the same reference numerals and detailed description thereof will be omitted.

Inner side surfaces 64 that belong to one 21 of the pair of tumbler insertion holes 21, 22 in the third engagement position P3, and face the half tumbler 32 from opposite sides, are formed to include at least: first guide portions 65 closely facing the half tumbler 32 and extending in the moving direction of the half tumbler 32; and first passage forming portions 68 having larger clearances with the half tumbler 32 than those of the first guide portions 65 in such a manner as to form first release passages 70 in spaces with the half tumbler 32 such that each first release passage 70 crosses the side edge portion of the key insertion hole 14, extends in the moving direction of the half tumbler 32, and has opposite ends opened to the outer surface of the rotor 13. In this embodiment, the inner side surfaces 64 of the tumbler insertion hole 21 include the first guide portions 65, and second and third guide portions 66, 67 closely facing the half tumbler 32 and extending in the moving direction of the half tumbler 32, while providing intervals in the direction orthogonal to the moving direction of the half tumbler 32.

The second guide portions 66 are located in such positions as to be continuous with the pair of partition walls 27, 28 arranged on the one diametric line L of the rotor 13, and to be divided into two portions by the key insertion hole 14. The inner side surfaces 64 of the tumbler insertion hole 21 are formed to have the first passage forming portions 68 between the first and second guide portions 65, 66. The first release passages 70 are formed between the first and second guide portions 65, 66 and between the inner side surfaces 64 of the tumbler insertion hole 21 and the half tumbler 32.

Meanwhile, the third guide portions 67 are located in positions continuous to an outer side surface of the tumbler insertion hole 21. The inner side surfaces 64 of the tumbler insertion hole 21 are formed to provide second passage forming portions 69 between the first and third guide portions 65, 67 in such a manner as to have larger clearances with the half tumbler 32 than those of the first to third guide portions 65, 66, 67. Second release passages 71 each extending in the moving direction of the half tumbler 32 and having one end opened to the outer surface of the rotor 13 are formed between the first and third guide portions 65, 67 and between the inner side surfaces 64 of the tumbler insertion hole 21 and the half tumbler 32.

Moreover, each second passage forming portion 69 is formed into an arc-shaped cross section for housing the spring 41 having the coil shape.

The inner side surfaces of the other tumbler insertion hole 22 in the third engagement position P3, and the inner side surfaces of the tumbler insertion holes 18 to 20 and 23 to 26 in the first, second, fourth, and fifth engagement positions P1, P2, P4, P5 are formed similarly to the inner side surfaces of the tumbler insertion hole 21 in the third engagement position P3.

The second embodiment can also achieve effects similar to those of the first embodiment.

Embodiments of the present invention are explained above, but the present invention is not limited to the above-mentioned embodiments and may be modified in a variety of ways as long as the modifications do not depart from the present invention described in claims.

1. A cylinder lock comprising:
a rotor with a circular cross-sectional shape having a key insertion hole at its central part, the rotor being rotatably fitted into a fixed cylinder body and including
tumbler insertion holes arranged on opposite sides or one side of one diametric line of the rotor and each having opposite ends opened to an outer surface of the rotor, the tumbler insertion holes being provided in a plurality of positions at intervals in an axial direction of the rotor while intersecting with part of the key insertion hole within planes orthogonal to an axis of the rotor;
a plurality of half tumblers each having an engagement portion on one of opposite end portions along the one diametric line, the half tumblers being respectively inserted into the tumbler insertion holes in such a manner as to be movable between engagement positions to cause the engagement portions to protrude from the outer surface of the rotor and disengagement positions to retract the engagement portions back into the tumbler insertion holes in response to insertion of a legitimate mechanical key into the key insertion hole;
springs respectively provided between the half tumblers and the rotor and configured to bias the half tumblers toward the engagement positions; and
locking recesses extending in the axial direction of the rotor and being provided in inner surfaces of an upper side wall and a lower side wall of the cylinder body such that the engagement portions of the half tumblers located in the engagement positions are capable of being inserted into and engaged with the locking recesses,
wherein
inner side surfaces of each of the tumbler insertion holes facing the corresponding half tumbler from opposite sides are each formed to include at least:
a guide portion closely facing the half tumbler and extending in a moving direction of the half tumbler; and
a passage forming portion having larger clearance between the passage forming portion and the half tumbler than clearance between the guide portion and the half tumbler in such a manner as to form a release passage between the passage forming portion and the half tumbler such that the release passage crosses a side edge portion of the key insertion hole, extends in the moving direction of the half tumbler, and has opposite ends opened to the outer surface of the rotor.

2. The cylinder lock according to claim 1, wherein
each inner side surface of each tumbler insertion hole is formed to include:
the guide portion; and
one or a plurality of other guide portions each closely facing the half tumbler and extending in the moving direction of the half tumbler, the guide portion and the other guide portion having a space therebetween in a direction orthogonal to the moving direction of the half tumbler.
